(19) United States
(12) Patent Application Publication
(10) Pub. No.: US 2025/0141044 A1
(43) Pub. Date: May 1, 2025

(54) INSULATING FILM FOR SECONDARY BATTERY AND METHOD FOR PRODUCING IT

(71) Applicants: TOSOH FINECHEM CORPORATION, Yamaguchi (JP); University of Miyazaki, Miyazaki (JP); TOSOH CORPORATION, Yamaguchi (JP)

(72) Inventors: Masahiro AOKI, Yamaguchi (JP); Haruna MORI, Yamaguchi (JP); Kenji YOSHINO, Miyazaki (JP); Masato IMAI, Miyazaki (JP); Atsushi MIYAZAWA, Tokyo (JP)

(21) Appl. No.: 18/493,807

(22) Filed: Oct. 25, 2023

(51) Int. Cl. H01M 50/434; H01M 50/403; H01M 50/417; H01M 50/451; H01M 50/489

(52) U.S. Cl. CPC H01M 50/434; H01M 50/403; H01M 50/417; H01M 50/451; H01M 50/489

(57) ABSTRACT

An insulating film for a secondary battery, which has desired insulating property and heat resistance, and which contributes to an increase of the energy density of a battery without considerable increase of the thickness. An insulating film for a secondary battery, including a substrate film which is a polyolefin microporous membrane, and having a metal oxide contained in the substrate film. In the insulating film, the metal oxide is contained in at least some of micropores and is present on the inner wall of the micropores. A method for producing the insulating film for a secondary battery is a method of spraying a solution containing an alkyl compound corresponding to a metal of the metal oxide and/or a partial hydrolysate of the alkyl compound over the substrate film, and drying the solution.

### TECHNICAL FIELD

The present invention relates to an insulating film for a secondary battery, and a method for producing it. More particularly, it relates to an insulating film for a secondary battery, which can be suitably used as a separator for a lithium ion secondary battery, which not only has favorable insulating property and heat resistance but also contributes to a membrane thickness reduction, and which promotes an increase of the energy density of a battery, and a method for producing such an insulating film.

### BACKGROUND ART

Heretofore, in order to improve heat resistance of a separator for a lithium ion battery and to prevent deterioration of a separator due to an increase of the energy density of a battery thereby to improve safety, a separator having an inorganic particle layer formed by using a specific binder laminated on at least one of front and back surfaces of a polyolefin porous membrane, has been proposed (for example, Patent Document 1).

Further, a separator for a lithium ion battery, comprising a polyolefin membrane containing colloidal inorganic particles having a predetermined particle size, and a microporous inorganic surface layer formed of an aqueous dispersion containing predetermined fumed inorganic particles, covering at least part of the polyolefin membrane, has been proposed (Patent Document 2).

### PRIOR ART DOCUMENTS

### Patent Documents

Patent Document 1: Japanese Patent No. 5354735
Patent Document 2: Japanese Patent No. 6761341

### DISCLOSURE OF INVENTION

### Technical Problem

However, with respect to the separator as described in Patent Document 1, as evident from the fact that an inorganic particle layer is laminated, impregnation of the inside of the polyolefin porous membrane with inorganic particles is not intended. Accordingly, the thickness of the separator considerably increases and the energy density of the battery may sometimes be decreased after all.

On the other hand, with respect to the separator as described in Patent Document 2, the thickness of the separator increases by the microporous inorganic surface layer covering the polyolefin membraned, and the inorganic particles may not infiltrate into the pores of the polyolefin membrane depending upon the particle size of the inorganic particles, thus leading to an increase of the thickness of the separator.

Further, in general, in production of lithium ion batteries, presence of moisture is restricted in raw material management and treatment step. However, by the surface treatment according to Patent Document 2, extensive drying step as a post-treatment and control of remaining moisture are necessary, and such makes the production complicated and may lead to non-uniformity of product quality and a decrease of production efficiency.

Under these circumstances, the present invention has been made to overcome such problems of prior art, and its object is to provide an insulating film for a secondary battery which has desired insulating property and heat resistance, and which contributes to an increase of the energy density of a battery without considerable increase of the membrane thickness, and a method for producing such an insulating film.

### Solution to Problem

The present inventors have conducted extensive studies to achieve the above object and as a result, found that the above object can be achieved by using a solution of a precursor of a metal oxide and by making the metal oxide be properly present in micropores of a microporous membrane, and accomplished the present invention. That is, the present invention provides the following.

(1) An insulating film for a secondary battery, comprising a polyolefin substrate film having a large number of micropores, at least some of which contain a metal oxide,
wherein the metal oxide is present on the inner wall of the micropores.
   (2) The insulating film for a secondary battery according to (1), wherein in observation of the cross section of the micropores, the occupation ratio of the metal oxide to the micropores, as represented by the cross sectional area of a metal oxide layer portion/the cross sectional area of the micropores×100(%), is from 5 to 20%.
   (3) The insulating film for a secondary battery according to (1) or (2), which has a metal oxide content of from 1 to 5 mass % to the total weight of the film.
   (4) The insulating film for a secondary battery according to any one of (1) to (3), wherein the metal oxide is unevenly present in the vicinity of the front surface or the back surface inside the film.
   (5) The insulating film for a secondary battery according to any one of (1) to (4), wherein the metal oxide is aluminum oxide.
   (6) The insulating film for a secondary battery according to (5), wherein the aluminum oxide is formed by partial hydrolysis of an alkylaluminum compound.
   (7) A method for producing the insulating film for a secondary battery as defined in any one of (1) to (6), which comprises spraying a non-aqueous solution containing an alkyl compound corresponding to a metal of the metal oxide and/or a partial hydrolysate of the alkyl compound over the substrate film and drying the non-aqueous solution, wherein the drying is carried out at from room temperature to 80° C.
   (8) The method for producing the insulating film for a secondary battery according to (7), wherein the alkyl compound corresponding to a metal of the metal oxide is an alkylaluminum compound.

### Advantageous Effects of Invention

According to the present invention, by using a solution of a precursor of a metal oxide and by making the metal oxide be properly present inside micropores of a microporous membrane, it is possible to provide an insulating film for a secondary battery which has desired insulating property and heat resistance and which contributes to an increase of the energy density of a battery without considerable increase of the membrane thickness, and a method for producing it.

### BRIEF DESCRIPTION OF DRAWINGS

FIG. 1 is a partial enlarged cross section illustrating an approximate shape of the insulating film for a secondary battery of the present invention.

FIG. 2 is TEM photographs of the insulating film in Example 1.

FIG. 3 is photographs illustrating the results of scanning transmission electron microscope/energy dispersive X-ray spectroscopy (STEM/EDX) of the insulating film in Example 1.

FIG. 4 is a graph illustrating results of XPS analysis of the insulating film in Example 1.

### DESCRIPTION OF EMBODIMENTS

Now, the insulating film for a secondary battery of the present invention will be described.

As described above, the insulating film for a secondary battery of the present invention comprises a polyolefin substrate film having a large number of micropores.

In the insulating film for a secondary battery of the present invention, a metal oxide is contained in at least some of micropores and is present on the inner wall of the micropores.

### <Structure, etc.>

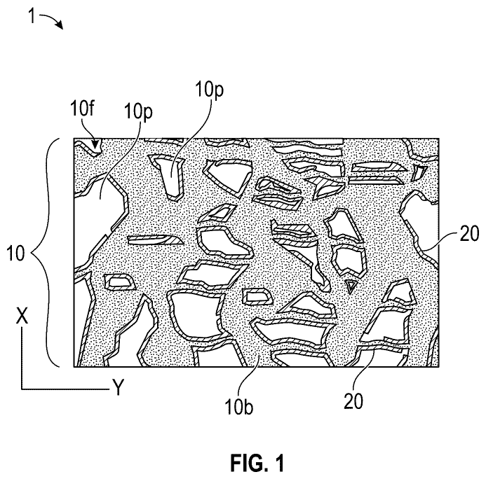

FIG. 1 is a partial enlarged cross section illustrating an embodiment of the insulating film for a secondary battery of the present invention, and illustrates a state where the insulating film is cut in a plane in parallel with its thickness direction.

In FIG. 1, the insulating film 1 according to the present embodiment has a substrate film 10 which is a microporous membrane having micropores 10p, and on the inner wall of the micropores 10p, a metal oxide 20 is present. Typically, the inner wall of the micropores and the metal oxide 20 are closely attached to each other substantially without gaps, and layers of the metal oxide are also closely attached to each other.

The micropores 10p may be connected in a random direction, such as a direction perpendicular to the paper, however, such a state is not illustrated.

Most of the micropores 10p present in the substrate film 10 are communicated with another micropore (not shown). Many of paths formed by such communication of micropores are paths that run from the front surface 10f to the back surface 10b of the substrate film 10 (hereinafter sometimes referred to as “through-paths”). Many of such through-paths connect the front and back surfaces of the substrate film 10 or the micropores, diverting or winding, however, they may penetrate the film linearly.

By such through-paths, flow of an electrolytic solution can be secured when the insulating film is used as a separator for a battery.

Here, in the insulating film 1 according to the present embodiment, it is not necessary that all the micropores 10p form the above through-paths, and paths which are open only to one of the front surface 10f and the back surface 10b may be present.

In this insulating film 1, the metal oxide 20 is present on the inner wall of the micropores 10p. In other words, the metal oxide 20 is present in a layer-form as closely attached to the inner wall of the micropores 10p covering the whole or a part of the inner wall surface, preferably most part of the inner wall surface.

By such presence of the metal oxide, the insulating film as a whole can have homogeneous insulting property and heat resistance. Further, since the content of the metal oxide can be increased substantially without increasing the thickness of the substrate film 10, not only insulating property and heat resistance can be improved but also the energy density of a battery for which the separator is used can be improved.

Heretofore, when an oxide layer is to be formed on the film surface, the denseness of the oxide layer has to be controlled so that the electrolytic solution can infiltrate inside. Further, if the electrolytic solution can not sufficiently wet the film, a special step to promote impregnation (infiltration) with the oxide is required, however, according to the present invention, infiltration with the oxide can readily be realized without such time and effort.

In observation of the cross section of the insulating film 1, the occupation ratio of the metal oxide to the micropores, as represented by the cross sectional area of the metal oxide layer portion 20/the cross sectional area of the micropores 10p×100(%), is preferably from 5 to 20%.

By the occupation ratio of from 5 to 20%, the film as a whole has desired insulating property and heat resistance, and the electrolytic solution will more favorably flow.

In the present invention, the content of the metal oxide in the insulating film is, to the total weight of the insulating film, preferably from 1 to 5 mass %.

When the content of the metal oxide is from 1 to 5 mass %, the film as a whole has desired insulating property and heat resistance, and the electrolytic solution will more favorably flow.

In the present invention, the metal oxide 20 can be made to be unevenly present on the front surface 10f side or the back surface 10b side of the insulating film 1.

By such uneven presence, for example, it is possible to increase the metal oxide on a side facing the cathode or to increase the metal oxide on a side facing the anode, thereby to efficiently improve heat resistance or to prevent short-circuiting by formation of dendrite.

### <Material, etc.>

Now, the material, etc., of the above-explained insulating film for a secondary battery will be described.

The substrate film is formed of a polyolefin and has a large number of micropores.

As the polyolefin forming the substrate film, typically, a polyethylene and a propylene may be mentioned.

When the insulating film for a secondary battery of the present invention is used as a separator for a lithium secondary battery, the thickness of the substrate film is preferably from 5 to 25 μm.

By the thickness of the substrate film of from 5 to 25 μm, it is possible to further prevent the film from being deformed by impregnation with a solution of a precursor of the metal oxide and drying the solution and to further maintain uniform dispersion of the metal oxide inside.

Further, when the insulating film is used as a separator, the micropores are preferably micropores having a pore size of about 1 μm or smaller, however, the micropores are not limited thereto.

The substrate film, which is the above-described microporous polyolefin membrane, may be prepared, for example, by stretching a polyolefin film prepared by a known method in one or more directions.

Such a substrate film may also be commercially available, for example, “Celgard” (tradename, manufactured by Asahi Kasei Corp.) may be used.

As the metal oxide, a material having both insulating property and heat resistance is suitable, and specifically, aluminum oxide may be mentioned.

In the present invention, the aluminum oxide may be formed by using a solution containing an alkylaluminum compound and/or a partial hydrolysate of the alkylaluminum compound, as described hereinafter.

### <Method for Producing Insulating Film for Secondary Battery>

Now, the method for producing the insulating film for a secondary battery of the present invention will be described.

The production method of the present invention is a method for producing the above-described insulating film for a secondary battery of the present invention, which uses a solution containing a non-aqueous solvent and an alkyl compound corresponding to a metal of the metal oxide and/or a partial hydrolysate of the alkyl compound, preferably uses the solution and the non-aqueous solvent of the solution.

By this production method, the solution is sprayed over the substrate film and dried, and this drying is carried out at from room temperature to 80° C. Spraying and drying may be conducted simultaneously, or drying may be conducted after spraying. It is easier to reduce the surface deposited layer thereby to prevent an increase of the film thickness, by conducting spraying and drying simultaneously. However, it is possible to effectively prevent an increase of the film thickness even by drying after spraying.

Further, in the production method of the present invention, it is preferred that the spraying and drying of the solution is followed by spraying and drying of the non-aqueous solvent of the solution. The continuous process of spraying and drying the solution and spraying and drying the non-aqueous solvent is carried out preferably at least once. By such spraying and drying of the non-aqueous solvent, infiltration of the metal oxide into the micropores of the substrate film can be accelerated.

Drying of the non-aqueous solvent may also be carried out at the same temperature as the drying of the solution.

The alkyl compound corresponding to a metal of the metal oxide may, for example, be an alkylaluminum compound, specifically trimethylaluminum (hereinafter sometimes abbreviated as “TMAL”), triethylaluminum, tri-n-propylaluminum, triisopropylaluminum, tri-n-butylaluminum, triisobutylaluminum, tri-t-butylaluminum, tri-n-pentylaluminum, tri-n-hexylaluminum, tri-n-heptylaluminum or tri-n-octylaluminum.

Further, the non-aqueous solvent may, for example, be a cyclic amide such as N-methyl-2-pyrolidone (hereinafter sometimes abbreviated as “NMP”), 1,3-dimethyl-imidazolidinone or 1,3-dimethyl-3,4,5,6-tetrahydro-2(1H)-pyrimidinone; an aliphatic hydrocarbon such as n-hexane, octane or n-decane; an alicyclic hydrocarbon such as cyclopentane, cyclohexane, methylcyclohexane or ethylcyclohexane; an aromatic hydrocarbon such as benzene, toluene, xylene or cumene; a hydrocarbon solvent such as mineral sprit, solvent naphtha, kerosine or petroleum ether; an ether such as diethyl ether, tetrahydrofuran, diisopropyl ether, dioxane, di-n-butyl ether, dialkylethylene glycol, dialkyldiethylene glycol or dialkyltriethylene glycol; or glyme, diglyme or triglyme solvent.

The non-aqueous solvent may be used alone or in combination of two or more. Such non-aqueous solvents may be properly selected depending upon production conditions and use conditions. For example, an amide solvent such as N-methyl-2-pyrolidone, which is commonly used for production of an electrode, an aromatic hydrocarbon solvent such as toluene or xylene, which is widely used industrially, and an ether solvent such as tetrahydrofuran or glyme, which is coordinated to a partial hydrolysate of the alkylaluminum and is stabilized, are suitably used.

In the production method of the present invention, the solution functions as a solution of a precursor of the metal oxide.

Such a solution, particularly a solution containing the alkylaluminum compound and/or a partial hydrolysate of the alkylaluminum compound, may be prepared in accordance with the method as described in Japanese Patent No. 6756634.

Such a solution preferably has an aluminum concentration of from 0.5 to 4 mass %. If the aluminum concentration is less than 0.5 mass %, the metal oxide in a desired amount may not infiltrate into the film inside, and if it is higher than 4 mass %, a large amount of the metal oxide may be deposited on the sprayed surface.

Further, the solution preferably has a turbidity of from 0 to 20.9 NTU, and a viscosity of from 1.743 to 2.790 mPa·s. By adjusting the turbidity and the viscosity to be within the above ranges, precipitation of gel and solid insoluble in the solvent may further be prevented.

In the production method of the present invention, the non-aqueous solution is, preferably the non-aqueous solution and the non-aqueous solvent are continuously, sprayed over the substrate film, typically on the surface of the substrate film, whereby the metal oxide deeply and widely infiltrate into the film through the micropores, and not much of the metal oxide remains on the surface of the substrate film, and thus close adhesion between the metal oxide and the inner wall of the micropores can be realized.

In addition, even when drying (including drying of the non-aqueous solvent) is conducted after the above spraying, substantially no metal oxide coating film is formed on the surface of the substrate film.

### EXAMPLES

Now, the insulating film for a secondary battery of the present invention will be described in further detail with reference to Examples and Comparative Examples. However, it should be understood that the present invention is by no means restricted thereto.

### Example 1

### <Material>

As a polyolefin microporous membrane for a substrate film, Celgard2400 (tradename, manufactured by Asahi Kasei Corp.) was used. The substrate film was a 25×25 mm square and had a thickness of 20 μm, and the micropores had openings of from 50 to 250 nm.

As a solution of trimethylaluminum (TMAL) partial hydrolysate (methylaluminoxane (MAO)) in NMP (N-methy-2-pyrolidone) as a solvent, that is a MAO/NMP solution, a 1% AI-MAO/NMP solution having an Al content of 1 mass % was used. NMP (N-methyl-2-pyrolidone) was manufactured by KISHIDA CHEMICAL CO., LTD., and TMAL (trimethylaluminum) was manufactured by LAKE MATERIALS.

The 1% AI-MAO/NMP solution had a turbidity of 20.9 NTU and a viscosity of 2.790 mPa·s. Further, the NMP solution had a turbidity of 10.0 NTU and a viscosity of 1.824 mPa·s.

### <Production Operations>

On a glass substrate, the above substrate film was placed and heated to 50° C., and on the front surface side (upper side), 1 ml of the 1% AI-MAO/NMP solution at a supply rate of 10 ml/h was sprayed in a stream of a carrier gas (nitrogen gas) at a flow rate of 8 l/min and dried simultaneously, to obtain an insulating film for a secondary battery in Example 1.

### Example 2

Following the spraying and drying of the 1% Al-MAO/NMP solution in Example 1, 1 ml of the NMP solvent was sprayed and dried in the same manner as the MAO/NMP solution to obtain an insulating film for a secondary battery in Example 2.

### <Evaluation of Performance>

### [Observation in Micropores]

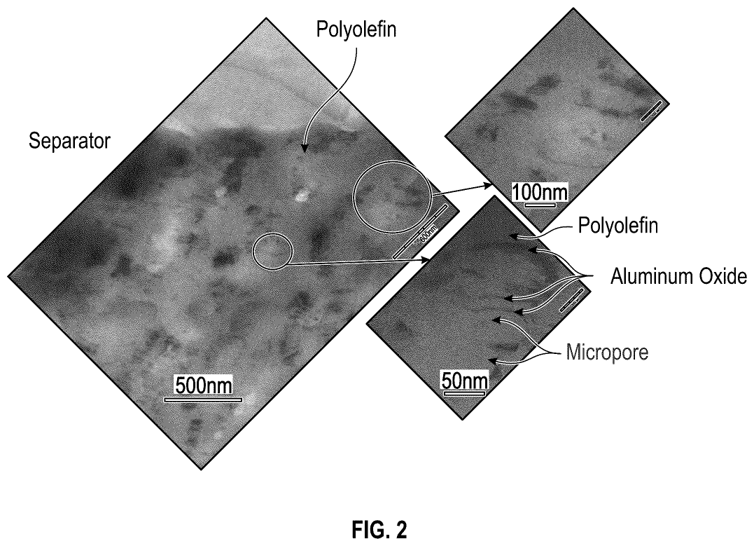

The insulating film for a secondary battery was subjected to TEM observation. The obtained results are shown in FIG. 2.

FIG. 2 is photographs of the insulating film in Example 1 cut in a plane in parallel with its thickness direction into a thin membrane, observed with a transmission electron microscope (TEM).

A contrast is presented on the TEM images due to a difference in electron beam absorption between carbon as the main component of the insulating film and aluminum oxide. That is, the aluminum oxide closely attached to the inner wall of the micropores in parallel with the observation direction has thickness in the depth direction (electron beam transmission direction), thus enhancing the contrast.

As shown in FIG. 2, it is evident that in the insulating film in Example 1, which falls within the scope of the present invention, the aluminum oxide is closely attached to the inner wall of the micropores in the cross section in parallel with the film thickness direction, and it is also evident that a void in the micropores remains with a relatively large volume. Accordingly, the film as a whole has favorable insulating property and heat resistance and when this insulating film is used for a separator, favorable flow of the electrolytic solution can be secured.

### [Confirmation of Metal Oxide (Component, Composition)]

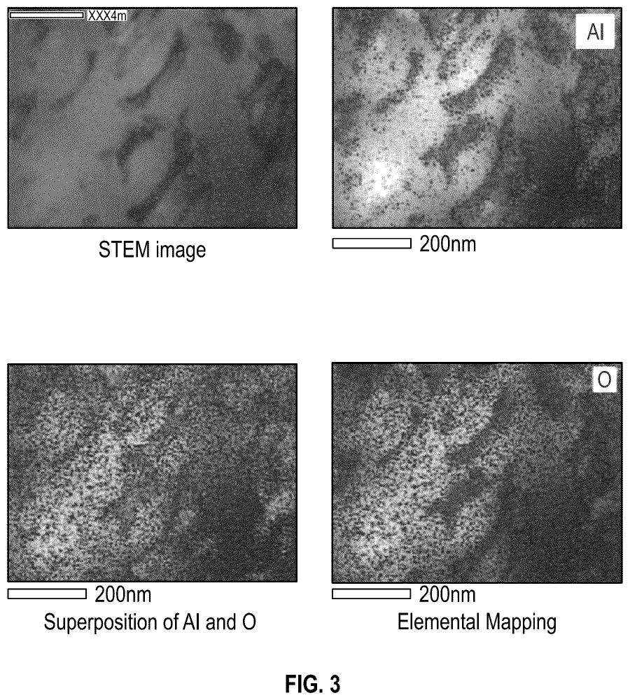

The insulating film in Example 1 was subjected to scanning transmission electron microscope/energy dispersive X-ray spectroscopy (STEM/EDX), and the obtained results are shown in FIG. 3.

In the STEM image, the contrast is high around the micropores in the film, and in this region, high concentration Al and O were detected by STEM/EDX. The compositional ratio of Al and O is a value close to 0.4 corresponding to the composition of aluminum oxide. From this viewpoint also, it is evident that the aluminum oxide is closely attached to the inner wall of the micropores inside the insulating film.

The formal names and the outlines of the techniques are as follows.

### STEM: Scanning Transmission Electron Microscope

A sample surface is scanned with electron probes focused to sub-nanometer beam diameters, and electrons transmitted through the sample are detected to acquire images.

### EDX: Energy Dispersive X-Ray Spectroscope

Characteristic X-rays emitted by irradiation with electron beams are detected, and from their energy, elemental analysis and compositional analysis are conducted.

### STEM/EDX

A sample is subjected to EDX analysis while scanned with electron beams by STEM, to conduct elemental analysis in a wide range.

### [Position (Depth Position) of Metal Oxide]

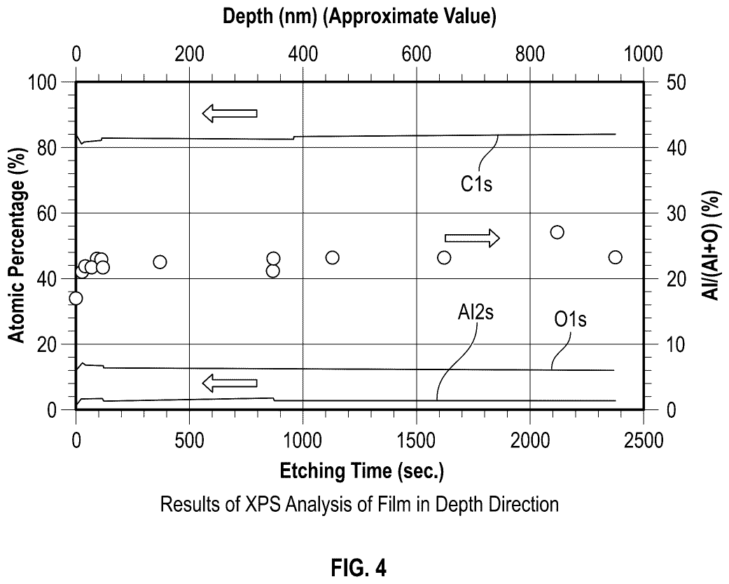

The insulating film in Example 1 was subjected to XPS analysis, and the obtained results are shown in FIG. 4.

The formal name and the outline of XPS are as follows.

XPS: X-ray Photoelectron Spectroscopy

A substance is irradiated with soft X-rays, and emitted photoelectrons are captured and subjected to energy analysis to conduct quantitative/qualitative analysis and chemical state analysis. Analysis in depth direction can be conducted by sputter etching with Ar ions.

As shown in FIG. 4, it is evident that in the insulating film in Example 1, the aluminum oxide is present at a depth of 1 μm or more from the film surface, and it is found that the aluminum oxide significantly infiltrate inside the micropores.

### (Increase of Film Thickness)

In the insulating films in the respective Examples, the thickness increase rate from the substrate film is about 1% or less in Example 1 and is about 1% or less in Example 2 also, and it is found that the thickness did not substantially increase.

### REFERENCE SYMBOLS

1: insulating film
10: substrate film
10p: micropore
10f: front surface of substrate film
10b: back surface of substrate film
20: metal oxide

What is claimed is:

1. An insulating film for a secondary battery, comprising a polyolefin substrate film having a large number of micropores, at least some of which contain a metal oxide,
wherein the metal oxide is present on the inner wall of the micropores.

2. The insulating film for a secondary battery according to claim 1, wherein in observation of the cross section of the micropores, the occupation ratio of the metal oxide to the micropores, as represented by the cross sectional area of a metal oxide layer portion/the cross sectional area of the micropores×100(%), is from 5 to 20%.

3. The insulating film for a secondary battery according to claim 1, which has a metal oxide content of from 1 to 5 mass % to the total weight of the film.

4. The insulating film for a secondary battery according to claim 1, wherein the metal oxide is unevenly present in the vicinity of the front surface or the back surface inside the film.

5. The insulating film for a secondary battery according to claim 1, wherein the metal oxide is aluminum oxide.

6. The insulating film for a secondary battery according to claim 5, wherein the aluminum oxide is formed by partial hydrolysis of an alkylaluminum compound.

7. A method for producing the insulating film for a secondary battery as defined in claim 1, which comprises spraying a non-aqueous solution containing an alkyl compound corresponding to a metal of the metal oxide and/or a partial hydrolysate of the alkyl compound over the substrate film and drying the non-aqueous solution, wherein the drying is carried out at from room temperature to 80° C.

8. The method for producing the insulating film for a secondary battery according to claim 7, wherein the alkyl compound corresponding to a metal of the metal oxide is an alkylaluminum compound.
